(19) United States
(12) Patent Application Publication
(10) Pub. No.: US 2002/0176567 A1
(43) Pub. Date: Nov. 28, 2002

(54) Method and apparatus for dynamically adjusting receiver sensitivity over a phone line home network

(76) Inventors: Cui Chen, San Jose, CA (US); Chung-Ching Tseng, Hsinchu (TW)

Correspondence Address: SILICON VALLEY PATENT AGENCY, INC., 7394 WILDFLOWER WAY, CUPERTINO, CA, 95014, US

(21) Appl. No.: 09/861,072

(22) Filed: May 18, 2001

Related U.S. Application Data
(60) Provisional application No. 60/277,197, filed on Mar. 19, 2001.

(51) Int. Cl. H04M 1/00; H04M 9/00

(52) U.S. Cl. 379/392.01

(57) ABSTRACT

A method and apparatus for dynamically adjusting receiver sensitivity over an existing phone line home network is disclosed. The method includes what is referred to Continuous Carrier Detect (CCD) adaptation process implemented by a state machine to quickly adapt to the on the fly wire DC offset in a matter of a few milliseconds for achieving optimal receiver sensitivity. According to one embodiment, a noise threshold level is dynamically generated for detecting noises in incoming data stream from the existing phone line home network.

### CROSS-REFERENCE TO RELATED APPLICATION

This application claims the benefits of the provisional application, No. 60/277,197, entitled “Method and Apparatus for Dynamically Adjusting Receiver Sensitivity over a Phone Line Home Network”, filed Mar. 19, 2001, which is hereby incorporated by reference for all purposes.

### BACKGROUND OF THE INVENTION

1. Field of the Invention

The present invention generally relates to computer networking technology and more particularly relates to a method and apparatus for dynamically adjusting receiver sensitivity over a network implemented upon a Phone Line System.

2. Description of the Related Art

The Internet is a rapidly growing communication network of interconnected computers and computer networks around the world. Together, these millions of connected computers form a vast repository of multimedia information that is readily accessible by any of the connected computers from anywhere at any time. Just as there is a critical need for high-speed connections to the information on the Internet, there is a growing need to rapidly move the information between devices within a home. Businesses accomplish this by deploying Local Area Networks (LANs), however, dedicated data networks are not commonly deployed in the home due to the cost and complexity of installing the new wiring system typically required by the traditional LANs. Nevertheless, there exists a phone line system in nearly every home in the United States. Therefore a great demand for a simple high-speed and cost-effective home network based on the existing phone line system is tremendously growing.

The driving force behind the home network is the growth of on-line households and the growing number of homes with two or more personal computers. It was reported that more than 47 percent of US households are likely to have Internet access devices by 2002, with some 20 percent of this subset owning multiple devices as that need to share access to the Internet as well as communicate with each other. Commonly assigned U.S. Pat. No. 6,137,865, which is hereby incorporated by reference, discloses a mechanism that permits data transmitted or received over an existing 4-wire (two-pair) home phone line system by using two transmitters along with two isolators and a receiver. As a result, Non-technical users can connect various computing devices onto a home network by simply plugging them into phone jacks (e.g. RJ-11 jack) in ordinary residential households.

The Home Phone Network Alliance (HomePNA, see www.homepna.org) organizes and develops standards and specifications for home networking devices employed over an existing twisted-pair phone wiring. The physical media carrier is usually the unshielded twisted pair (UTP) telephone wire of either category 1 or category 2 cables which allows data transportation one way (half-duplex) at a speed of one Mega Bit Per Second (1 Mbps) that is defined in the HomePNA specification version 1.0. There have been many efforts in developing products compliant with the HomePNA standards or specifications. One of the products is a transceiver that could be used to implement U.S. Pat. No. 6,137,865. However, a network device may not perform properly due to various background noises if the transceiver in the network device is not designed to handle the noise situations properly. There is therefore a need for a method and apparatus that can dynamically handle the various background noises to ensure that the network device function properly.

### SUMMARY OF THE INVENTION

In consideration of the above-discussed issues and needs, the present invention discloses a logic circuit, a method or process to achieve an adaptive noise threshold. A determination process (i.e. a state machine) is configured to quickly adapt to the on the fly wire noise level after reset/power up in order to achieve an optimal receiver sensitivity. According to one aspect of the invention, a distinct process, referred to as Continuous Carrier Detect (CCD) adaptation process, is activated to quickly track the on the fly wire DC offset that the noise signal sits on within a short period (e.g. a few milliseconds). Both the noise tracking level and the noise floor level (minimum noise level setting) are reset before the CCD adaptation process starts. A new noise threshold is then derived from adding a small offset to the tracked DC level at the end of the short period.

A link status is incorporated into the present invention to take into consideration that (a) at power up, a temporary noise surge may occur on the line, which could lead to an initial noise threshold being set too high to establish a successful link, and (b) whenever the link is down, it infers that either a magnitude of an envelope signal above its baseline is too small or the noise threshold is set too high, or the physical connection is broken. Without resetting to start over tracking the wire noise level, only the noise floor value is reset to allow the normal noise adaptation process to be able to go to a lower level if no noise pulse is detected in one second, thereby adapting to a new noise level. For cases in which the magnitude is small, a programmable offset register (e.g. 6-bit) allows user to use a different offset value being added to the DC level to fine-tune the noise threshold.

The present invention also considers the effect of transmit power change on the noise threshold level. Whenever a change of transmit power is detected, the logic in the present invention will give a first priority like a reset/power-up event, i.e. the state machine will directly restart the CCD-adaptation process.

According to one embodiment, the present invention is implemented as a transceiver. The transceiver is coupled to a data network implemented over a phone line, for dynamically adjusting sensitivity thereof. The transceiver comprises a first analog transmitter and a second analog transmitter receiving transmitting time signals from a transmit time generator; an analog receiver including a differential amplifier and a rectifier, the differential amplifier receiving a pair of differential waveforms from the first analog transmitter an analog receiver including a differential amplifier and a rectifier, the differential amplifier receiving a pair of differential waveforms from the first analog transmitter and propagates the amplified differential waveform to the rectifier that subsequently produces an envelope signal; the analog receiver further includes a slicer receiving comparing signals (SLICE_LVL_NOISE, SLICE_LVL_PEAK, SLICE_LVL_DATA) from a digital receiver and the envelope signal from the rectifier and subsequently producing resultant signals (NOISE, PEAK, DATA), also referring to as decision signal back to the digital receiver.

According to another embodiment, the present invention is implemented as a method for dynamically adjusting sensitivity of a transceiver coupled to a data network implemented over a phone line system, the method comprising: determining a state from a state machine receiving a plurality of control signals, the state controlling how to generate a digital signal from a counter; producing a comparing signal from the digital signal; generating an envelope signal from a rectifier that receives an amplified differential signal, wherein the amplified differential signal is produced from a differential amplifier receiving differential waveforms; and comparing the envelope signal with the comparing signal (i.e. a noise threshold level) to produce a resultant or decision signal (i.e. NOISE) that is to be used in the digital CCD noise adaptation process and digital receiver control logic.

Accordingly, an important object of the present invention is to dynamically generate a noise threshold for detecting noises over a phone line.

Other objects, together with the foregoing are attained in the exercise of the invention in the following description and resulting in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1A shows a typical home network over an existing telephone wire structure in a residential home;

FIG. 1B illustrates a pair of transceivers in relationship to a LAN (Local Area Network) or OSI (Open System Interconnection) Model;

FIG. 2A shows a functional block diagram of a transceiver according to one embodiment of the present invention, the transceiver including a mixture of a digital receiver and an Analog Front End (AFE) block;

FIG. 2B illustrates an exemplary envelope signal being compared with three comparing signals, one of which is a noise threshold signal, to produce three decision signals PEAK, DATA and NOISE, corresponding to FIG. 2A;

FIG. 3 shows a top-level block diagram of a modem as a physical layer for connecting to the upper MAC layer in the Ethernet CSMA/CD protocol stack;

FIG. 4 shows a state machine diagram for DC-tracking according to one embodiment of the present invention;

FIG. 5 shows the circuit logic of block DCTRACK for the DC-track control logic of the invention;

FIG. 6A shows a possible follower control logic used in a traditional device;

FIG. 6B shows an embodiment of a noise follower control logic according to the present invention; and

FIG. 7 shows one exemplary implementation of a relevant control logic change in a squelch block of a digital receiver used in the present invention.

### DETAILED DESCRIPTION OF THE PREFERRED EMBODIMENTS

The present invention may be advantageously used in communication devices to facilitate smooth data communication among the devices. One of the advantages and benefits in the present invention is the mechanism that allows a dynamic detection of noise threshold level. In the traditional devices, a noise threshold level is predetermined based on calculations or empirical data obtained from a phone line network. Often times, the noise threshold level so defined may either over-detect or under-detect noises over the phone line network, resulting in possible malfunctioning of network devices. With the present invention, the noise threshold level can be dynamically determined from an incoming data stream so that the noises in the data stream can be effectively detected.

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention. The detailed description of the invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Furthermore, the order of blocks in process flowcharts or diagrams representing one or more embodiments of the invention do not inherently indicate any particular order nor imply any limitations in the invention.

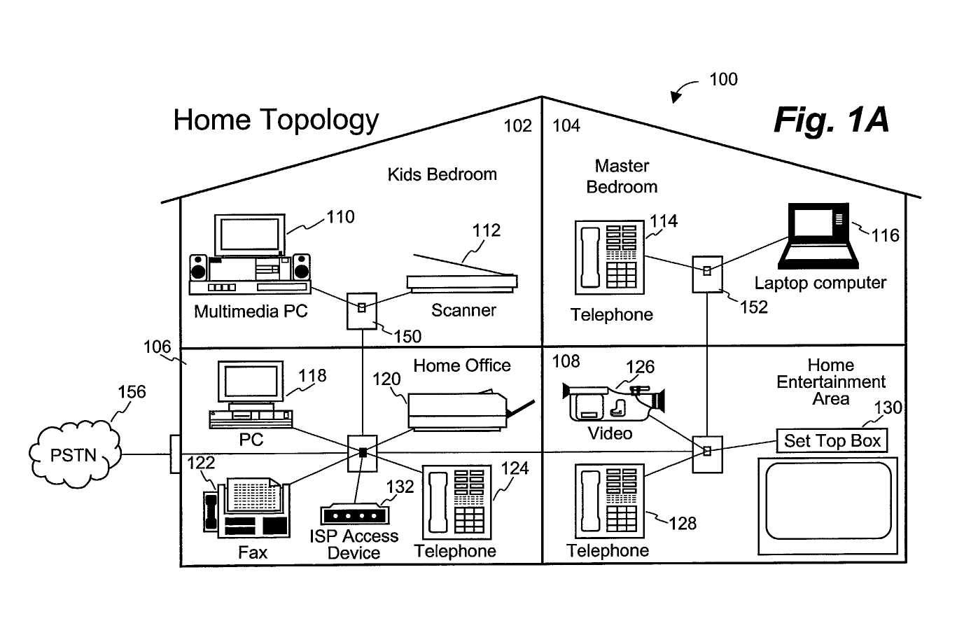

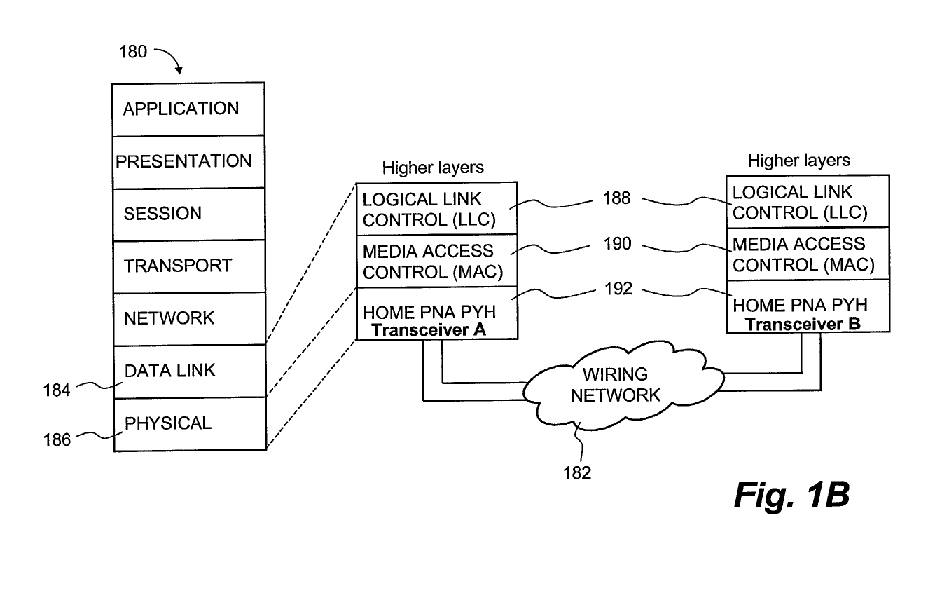

Referring now to the drawings, in which like numerals refer to like parts throughout the several views. FIG. 1A shows an exemplary home configuration in which the present invention may be practiced. As shown in the figure, there are four rooms 102, 104, 106 and 108 in the house 100, each having electronic devices that are coupled to a home data network. The home data network is implemented upon a phone line system in the house 100 and may be coupled to the Internet via an Internet service provider access device 132 (e.g. a modem).

With reference to FIG. 1A, there are shown a multimedia personal computer 110 and a scanner 112 in the kid's bedroom 102, a telephone 114 and laptop personal computer 116 in the master bedroom 104, a desktop personal computer 118, a printer 120, a telephone 124 and a fax machine 122 in the home office 106, and a video camera 126, a telephone 128 and a set-top box 130 in the home entertainment area 108. To be more specific, telephones 114, 124 and 128 and fax machine 122 are generally coupled to the phone line system for phone services while other devices, referred to herein as computing devices, are coupled to the phone line system for home data networking. Each of the computing devices may share data produced in another device. For example, The scanner 112 in the kids room generates an image of a picture, the image can be transmitted to the personal computer 118 for further editing process and finally the edited image can be printed from the laser printer 120, all via the home data network.

The home data network is implemented over the phone line system. Although all devices are connected to the same phone line system, only telephones 114, 124 and 128 and fax machine 122 communicate with the public switched telephone network (PSTN) 156. The rest of the devices communicate over the home data network may or may not communicate with PSTN 156 but communicate among themselves.

For the computing devices to communicate with each other or a server on the Internet, U.S. Pat. No. 6,137,865 discloses a mechanism that permits data transmitted or received over an existing 4-wire (two-pair) home phone line system by using two transmitters along with two isolators and a receiver. According to one embodiment of the present invention, an apparatus, referring to as a transceiver, can be used in or associated with the transmitter/receiver to facilitate the data communication between computing devices over a home phone network.

FIG. 1B illustrates a pair of transceivers in relationship to a LAN (Local Area Network) or OSI (Open System Interconnection) Model. Transceiver A and transceiver B are respectively in two different network devices coupled to a home phone network 182. In other words, the network devices are communicating with each other over network 182. To facilitate the understanding of the present invention, a reference protocol stack 180 is illustrated on the side, wherein the layer 186 corresponds to layer 192 at which transceiver A and transceiver B operate. Accordingly, a transceiver herein is also referred to as a physical layer device supporting home phone networking.

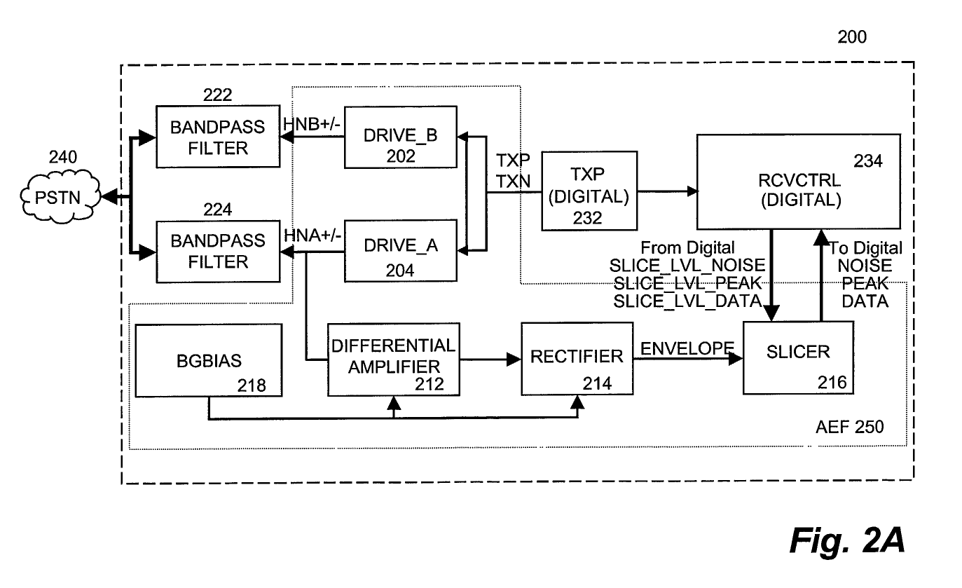

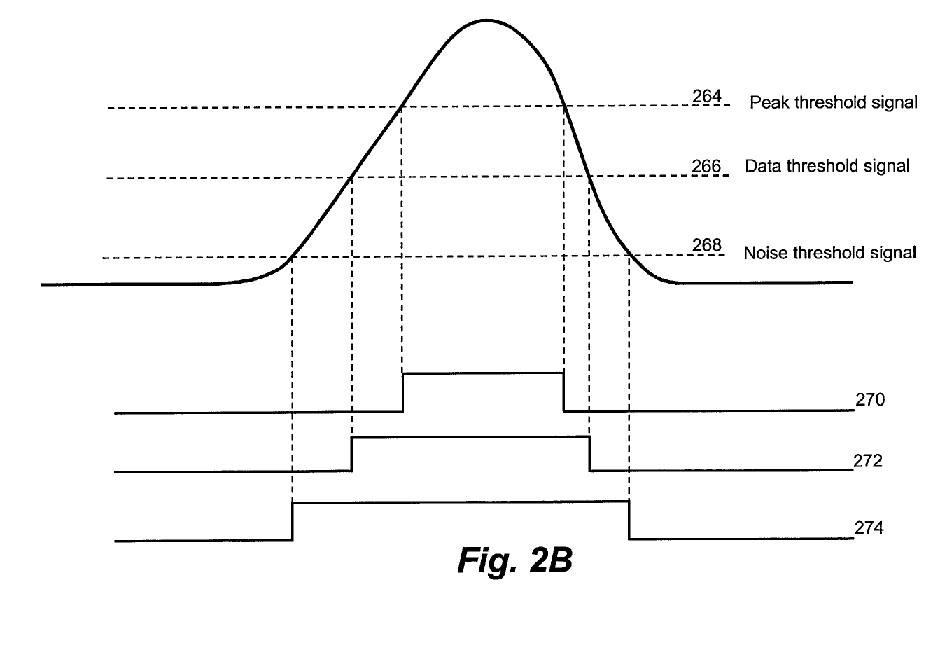

FIG. 2A shows a functional block diagram of a transceiver 200 according to one embodiment. Transceiver 200, enabling 4-wire operation, includes two bandpass filters 222 and 224, an Analog Front End (AFE) 250, digital transmit timing generator TXP block 232 and a digital receiver control block 234 (or digital receiver interchangeably herein). The bandpass filter, associated with the isolation circuit 106 of U.S. Pat. No. 6,137,865, isolates the data operations from the regular phone services on the phone lines so that the normal telephone communication can be carried out without being disturbed due to the data networking over the phone lines. In one example, the band-pass filter has a cutoff frequency of 6.0 MHz and 9.0 MHz respectively for the lower and higher band and is AC coupled to the PSTN 240. Preferably, the band-pass filter includes protection circuitry, isolation and EMI filtering.

AFE receiver 250 includes two analog transmitters 202 and 204 associated respectively with two bandpass filters 222 and 224, and a receiver that is composed of a differential amplifier 212, a rectifier 214, a slicer 216 and a BGBIAS (Bandgap Bias) block 218. Two transmitters 202 and 204, also referring to two drivers as shown in the figure as DRIVER_A and DRIVER_B, receive simultaneously from digital TXP block 232 two differential transmitting pulses (TXP, TXN) and output the differential multiple cycle waveform ±HNA, ±HNB to the two corresponding band-pass filters that finally via a phone jack (e.g. RJ-11 jack, not shown) couple to the PSTN 240. It should be noted that the use of “transmitters” herein do not necessarily mean the transmitters used in U.S. Pat. No. 6,137,865.

The AFE receiver receives the differential waveforms ±HNA from DRIVER_A 204 and diverts the waveforms to the inputs of the differential amplifier 212 that propagates the output, i.e. an amplified differential waveform, to the input of the rectifier 214. As a result, an envelope signal, ENVELOPE, is produced from rectifier 214 and coupled to the slicer 216.

According to one embodiment, the slicer includes three comparators, with one of them receiving from the digital receiver block 234 a digital signal, e.g. an 8-bit noise slice number SLICE_NOISE[7:0]. The digital signal is then converted into a comparing signal (e.g. through a RC circuit or a D/A converter). That is compared with the ENVELOPE signal to output a decision signal NOISE. For completeness, the other two comparators in the slicer receive a second and a third digital signal, namely, a peak threshold signal and a data threshold signal. FIG. 2B illustrates an exemplary envelope signal 262 being compared with three comparing signals, a peak threshold signal 264, a data threshold signal 266 and a noise threshold signal 268. With the appropriate comparing signals, decisional signals 270, 272 and 274 are generated and respectively labeled as PEAK, DATA and NOISE, corresponding to FIG. 2A. According to one embodiment, the decision signal NOISE outputs and is coupled back to the digital receiver 234. Block BGBIAS 218 sends control signals to both differential amplifier 212 and rectifier 214 to serve as a voltage reference by compensating for the effect of temperature through a feedback circuit.

Different from the traditional transceivers that are mostly discreet Analog Front End (AFE) and digital FPGA control logic with a predetermined or prefixed noise threshold level, transceiver 200 is a mixed-signal single chip solution. In one embodiment, transceiver 200 is implemented in Application Specific Integrated Circuit (ASIC). The use of ASIC has the obvious advantages of much lower cost, high performance and ease of system debug/maintenance by greatly reducing the problem sources/causes associated with the numerous PCB-trace connected discreet components on the system caught later in the field.

The ASIC implementation in CMOS, however, cannot perform well when the noise threshold level is fixed. Generally, the cause of the problem is two-folded. First, the DC offset of the output ENVELOPE from rectifier 214 in FIG. 2 varies from chip to chip, with values ranging from, for example, 200 mV to 1.8V, whereas a fixed noise threshold level typically has a value within a few tens mV. The much higher DC offset at ENVELOPE is due to the fact that the bias voltage in ASIC AFE (e.g. AFE 250) is 0-3.3V, whereas the prior art (e.g. non-CMOS implementation) is biased at ±5V and therefore results in a nearly zero ENVELOPE baseline. The minimum noise threshold (maximum receiver sensitivity) is usually set from the typical DC offset at ENVELOPE plus a small margin (e.g. around 30 mV). The unpredictable DC offset at ENVELOPE requires an adaptive minimum noise threshold setting instead of a fixed or static setting. Secondly, in the traditional transceivers, a default (e.g. 25%) increment of noise threshold is employed during packet receiving.

Consider a typical case with DC offset at 800 mV. With 25% default increment; the noise threshold will be 1.0V. With an ENVELOPE amplitude above the DC offset of 100-200 mV, the noise slice level sits around or even beyond/above the top of the ENVELOPE, which leads to over-kill for the proper receiving.

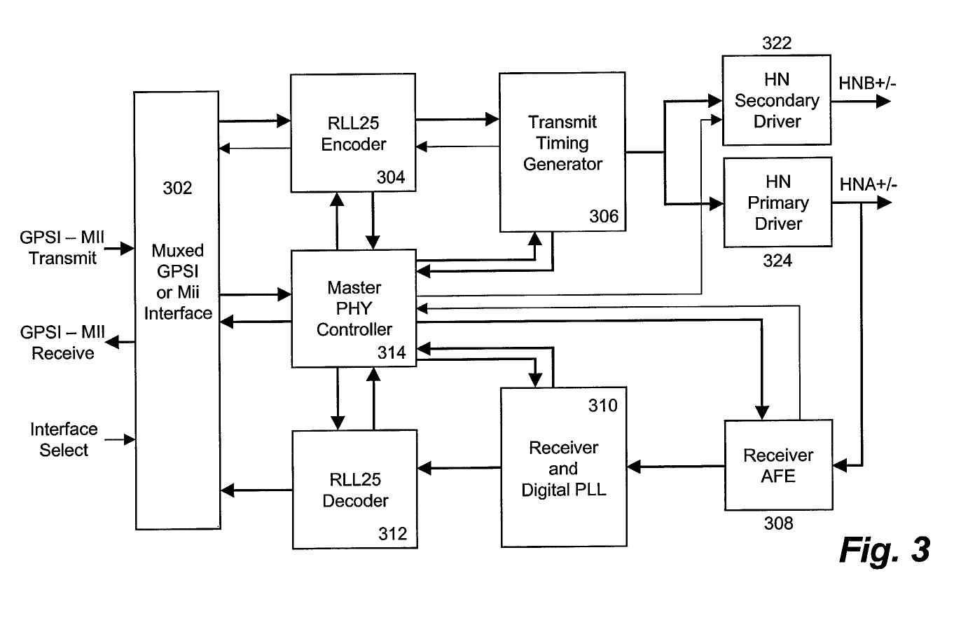

FIG. 3 shows a functional block diagram of a modem as a physical layer for connecting to the upper MAC layer in the Ethernet CSMA/CD protocol stack. With reference to FIG. 2, it shows functional coupling relations of the various digital control blocks, AFE drivers and an AFE receiver. Block 302 is the interface of the PHY tranceiver to the MAC controller multiplexed to either a General Purpose Serial Interface (GPSI) or a Media Independent Interface (MII). The RLL25 Encoder 304 encodes an incoming data stream into a variable length symbol with a Run Length Limit (RLL25) algorithm. Block 306 is a digital transmit timing generator, which generates the positive TXP and negative TXN transmit pulses for two drivers 322 and 324, each corresponding to transmitter 202 or 204 of FIG. 2. In addition, the transmit timing generator 306 determines how many pulses and the period of the transmitting pulses, and controls when the transmit pulses elapse and another one must be sent.

Block 322 and 324 are the two drivers in the analog AFE that has been described in FIG. 2A. Block 308 is the AFE including the digital portion of the AFE. It interfaces with the analog AFE of FIG. 2A, converts and synchronizes signals NOISE, DATA and PEAK from the slicer comparator outputs (see FIG. 2A) into digital signals, and generates receiving clocks. Block 310 is the digital receiver, which includes a sub-block squelch that generates the output signals SLICE_LVL_NOISE, SLICE_LVL_DATA, and SLICE_LVL_PEAK to the slicer in FIG. 2A.

Block 312 is the RLL25 decoder, which decodes the RLL25 symbols into outgoing bit stream to GPSI or Mll interface 302. Block 314 includes the master PHY control logic and the 1M8 header framing control. The master control is responsible for the data flow between all the other blocks and interfaces of the modem and generates the mode of operation. The 1M8 header framing is responsible for collision detection by transmitting an access identifier. Upon transmitting to the wire, it strips off the 8 octets preamble and delimiter and replaces with the 1M8 header, while upon receiving it strips off the 1M8 header and replaces with the last 4 octets preamble and delimiter of the IEEE 802.3u MAC frame specifications and then pass back to the MAC layer.

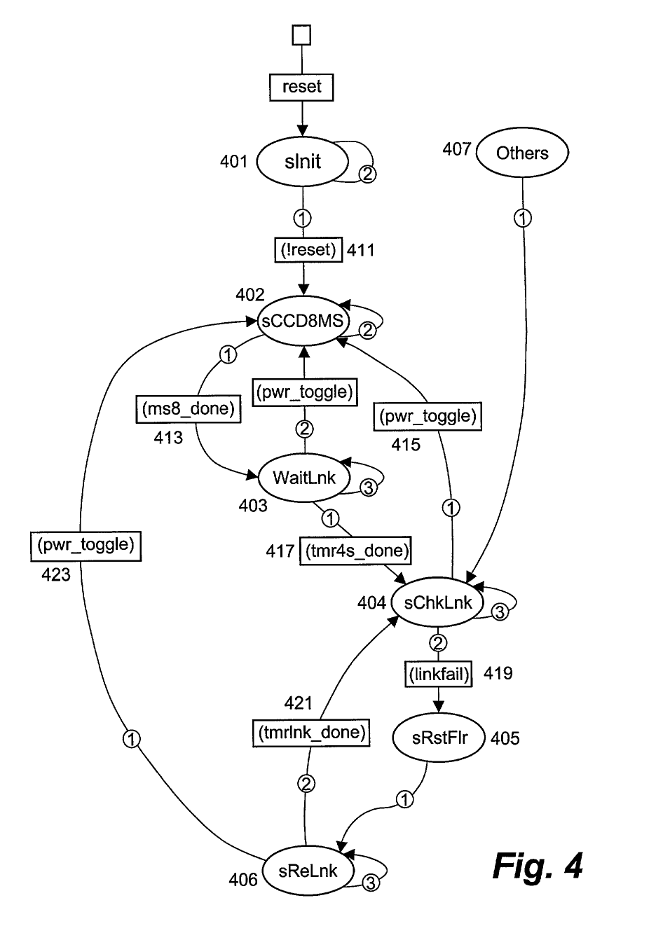

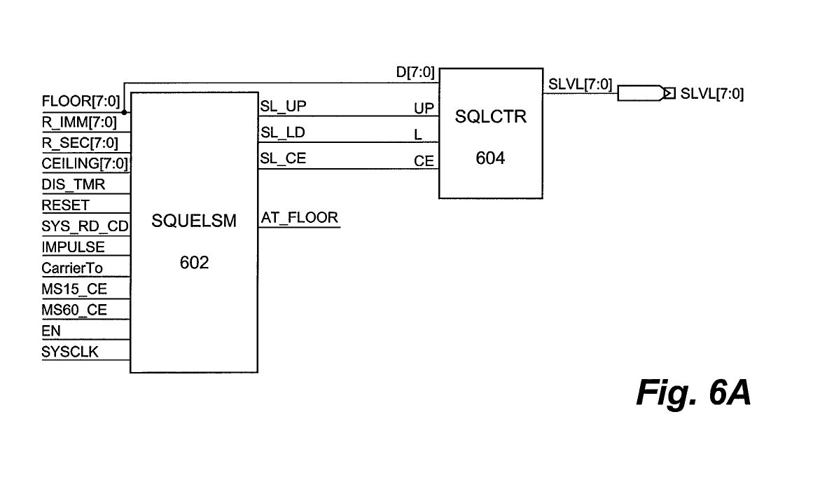

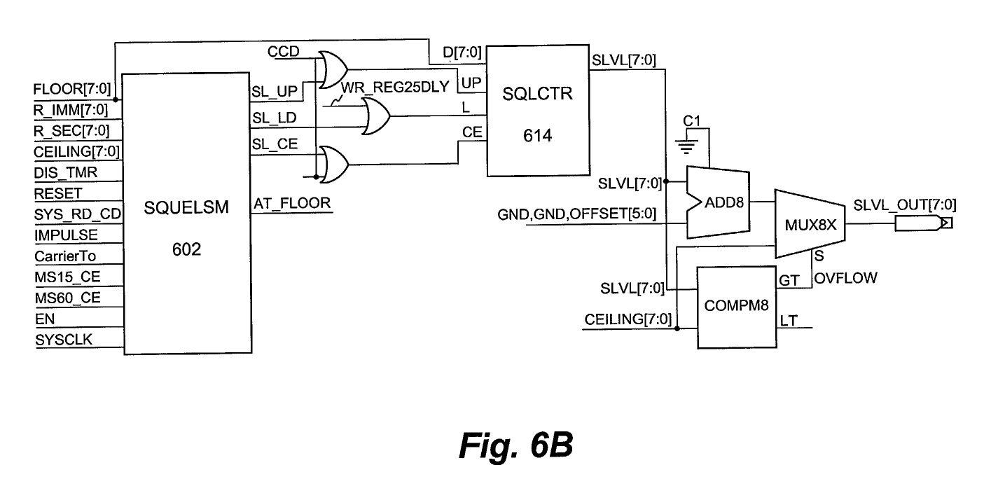

FIG. 4 shows a state machine diagram for DC-tracking according to one embodiment of the present invention. Upon reset or power up, the initial state slnit 401 is entered. After reset is released 411 in state slnit 401, it enters into state sCCD8MS 402 in which a time duration is set for using Continuous Carrier Detect (CCD) noise tracking/adaptation process that is explained below in more detail. In one embodiment, the time duration is set for an eight-millisecond timer to expire. Once the time duration expires (ms8_done 413), state 402 enters into state sWaitLnk 403. State 403 waits for, for example, a four second timer to expire (tmr4s_done 417) allowing time for a link being established, and if no power toggles in state 403 and the four second timer expires, it will enter into state 404. State sChkLnk 404 checks if the link is on, and if yes, it will do nothing just wait there. Otherwise if the link fails in state sChkLnk 404 (linkfail 419), state sRstFlr 405 is entered, and one clock cycle later enters state sReLnk 406. In state sReLnk 406, a normal noise tracking process is used rather than the CCD adaptation process, which is generated by the noise follower state machine SQELSM in FIG. 6A. Again state sReLnk 406 waits for a four-second-link timer to expire (tmrInk_done 421). If no transmit power changes and the four-second-link timer expires, state sReLnk 406 goes to state sChkink 404 for link status recheck and monitoring. Otherwise, if either in state sReLnk 406 or in state sChkLnk 404 a change of transmitting power (pwr_toggle 423, 415) is detected before the corresponding four-second-link timer expires or regardless of the link status, the state machine will go back to state sCCD8MS 402 to allow the CCD noise adaptation process take the first priority and start over again.

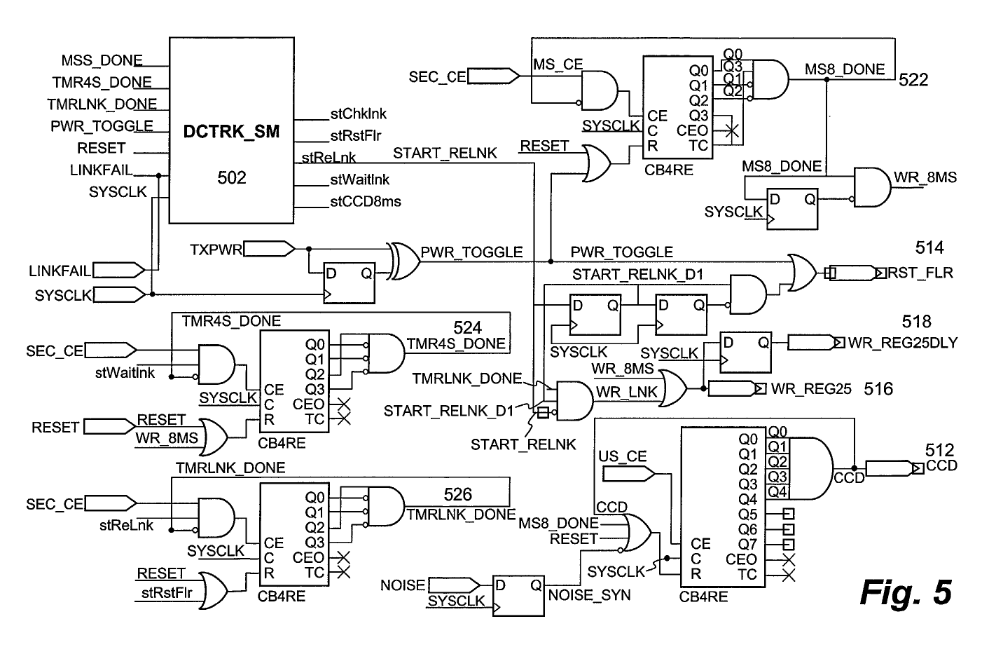

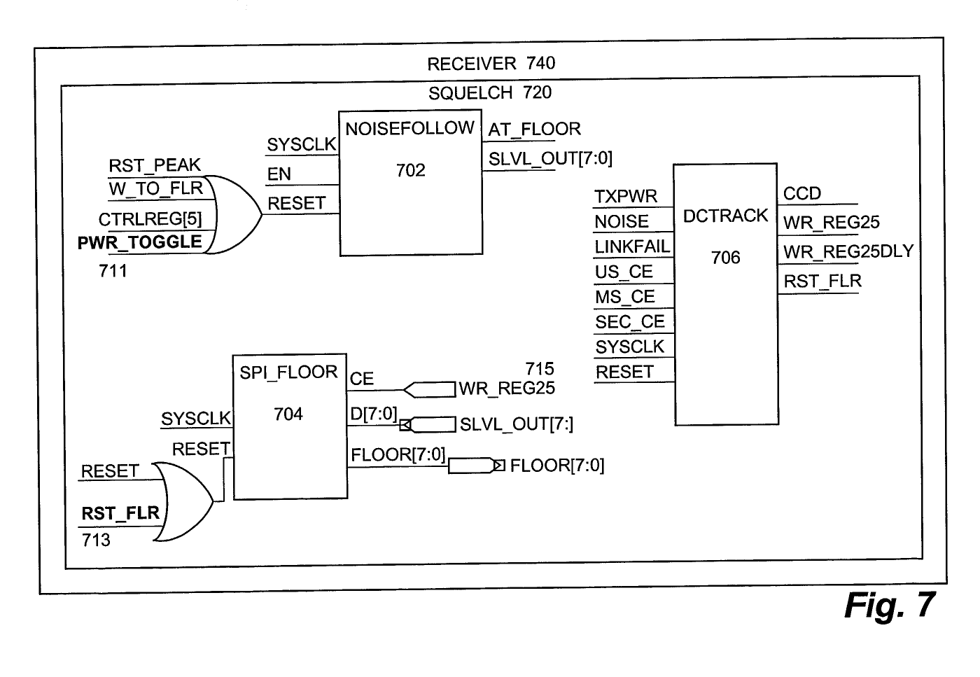

FIG. 5 shows an exemplary circuit functional diagram, called DCTRACK, for the DC-track control logic according to one embodiment of the invention. It includes the state machine subblock DCTRK_SM 502 and the control logic for generating state machine control signals and output signals to FIG. 6B and FIG. 7. Table 1 shows (a) the input and (b) the output port signal definitions of block DCTRACK.

TABLE 1
(a) Input port signal definition in DCTRACK

| Input | |
|---|---|
| Name | Description |
| TXPWR | This signal is CTRLREG[1] indicating PHY's transmitting |
| | power. Active high. |
| NOISE | This is the output signal from the analog noise |
| | comparator in the slicer block 216 in FIG. 2. |
| LINKFAIL | This signal is from LINK block (not shown), which |
| | indicates the link status. |
| US_CE | This is a one SYSCLK wide pulse with a period of 1 |
| | μsec. |
| MS_CE | This is a one SYSCLK wide pulse with a period of 1 |
| | msec. |
| SEC_CE | This is a one SYSCLK wide pulse with a period of 1 sec. |
| SYSCLK | This is the 20 MHz system clock. |
| RESET | This is the hw/sw reset input. |

TABLE 1
(b) Output port signal definition in DCTRACK

| Output Name | Description |
|---|---|
| CCD | CCD is a one SYSCLK wide pulse generated |
| | every 32 μs to increment/decrement and |
| | clock enable the counter 614 in FIG. 6B. |
| WR_REG25 | Wr_REG25 715 is output to SQUELCH block |
| | 720 for enabling the new noise adapting |
| | value being written to the noise floor register, |
| | as shown in FIG. 7. |
| WR_REG25DLY | Wr_REG25DLY is for loading the newly |
| | written FLOOR[7:0] value into the noise |
| | adapting register SLVL[7:0] in FIG. 6b. |
| RST_FLR | RST_FLR 713 will reset FLOOR[7:0] in the |
| | subblock SPI_FLOOR 704 of block |
| | SQUELCH 720 of FIG. 7 if either the |
| | transmitting power changes or at the start of |
| | state sReLnk. |

According to one embodiment, the output CCD is one SYSCLK (20 MHz) wide pulse generated every 32 μsec as long as the noise comparator (e.g. in the slicer 216 of FIG. 2) is being held on during the 8 msec CCD-adaptation time window. Output RST_FLR 514 is generated if either transmitting power changes or at the onset/rising-edge of state sReLnk. Output WR_REG25 516 is generated at the end of the 8 msec CCD-adaptation time window or at the end of the state sReLnk and link timer is done. Output WR_REG25DLY 518 is just the one SYSCLK delayed signal of WR_REG25 for loading the newly written FLOOR[7:0] value (by WR_REG25 in FIG. 7) into the noise adapting register SLVL[7:0] in FIG. 6b. In addition, block DCTRACK generates signal MS8_DONE 522, TMR4S_DONE 524 and TMRLNK_DONE 526 used as the control signals in state machine DCTRK_SM 502.

FIG. 6B shows an exemplary noise follower control logic according to one embodiment of the invention. For comparison, FIG. 6A shows an example used in a prior system. The normal noise adaptation algorithm is generated by the state machine in SQUELSM block 602 and controls the 8-bit counter SQLCTR 604 to raise or lower the noise threshold level controlled by SL_UP, or load the counter with the FLOOR[7:0] value by SL_LD, and the clock enabling signal SL_CE. While in FIG. 6B, both the increment control SL_UP and clock enable control SL_CE will be also activated if the CCD output from FIG. 5 is true. The load control SL_LD is activated also by the output signal WR_REG25DLY from FIG. 5 in order to update the SLVL[7:0] values to the newly written FLOOR[7:0] value. The output of the 8-bit counter SQLCTR 614 is then added to a user-programmable 6-bit offset value. If SLVL[7:0] is less than or equal to the noise ceiling setting CEILING[7:0], then the added result is output as SLVL_OUT[7:0]. Otherwise, i.e. if SLVL[7:0] is greater than the noise ceiling setting CEILING[7:0], the ceiling register value will be output as SLVL_OUT[7:0].

FIG. 7 shows the relevant control logic change in block squelch within the digital receiver block of the present invention. The SQUELCH block contains sub-block NOISEFOLLOW 702 as depicted partially in FIG. 6B, a 8-bit noise floor register SPI_FLOOR 704, and an added block DCTRACK 706 which is the major part of this invention, as depicted in FIG. 5. Every time power changes (PWR_TOGGLE 711), the noise adapting register SLVL_OUT[7:0] will be reset to the FLOOR register value to re-track the DC level on the wire by the CCD-adaptation algorithm. The FLOOR[7:0] will be also reset by signal RST_FLR 713 if either the transmitting power changes using CCD-adaptation algorithm or at the start of state sReLnk using normal noise adaptation algorithm. At the end of the 8 ms CCD-adaptation time window or at the end of the state sReLnk and link timer done, the SLVL_OUT[7:0] is written to the SPI_FLOOR 704 register to get the new FLOOR value compatible to the on-the-fly wire noise environment.

One of the advantages and benefits in the present invention is the mechanism that allows a dynamic detection of noise threshold level. In the traditional devices, a noise threshold level is predetermined based on calculations or empirical data obtained from a phone network. Often times, the noise threshold level so defined may either over-detect or under-detect noises over the phone network, resulting malfunctioning of network devices. With the present invention, the noise threshold level is dynamically determined from an incoming data stream.

The processes, sequences or steps and features discussed above are related to each other and each is believed independently novel in the art. The disclosed processes and sequences may be performed alone or in any combination to provide a novel and unobvious device/method. The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

We claim:

1. A transceiver, coupled to a data network implemented over a phone line, for dynamically adjusting sensitivity thereof, the transceiver comprising:
a first analog transmitter and a second analog transmitter receiving transmitting time signals from a transmit time generator;
an analog receiver including a differential amplifier and a rectifier, the differential amplifier receiving a pair of differential waveforms from the first analog transmitter and propagates the amplified differential waveform to the rectifier that subsequently produces an envelope signal;
the analog receiver further includes a slicer receiving a comparing signal and the envelope signal and subsequently producing a noise decision signal for detecting noises in received data stream over the data network.

2. The transceiver of claim 1, wherein the first analog transmitter couples to a first bandpass filter and the second analog transmitter couples to a second bandpass filter, both of the first and second bandpass filters coupled onto the data network.

3. The transceiver of claim 1, wherein the transmitting time signals are two differential transmitting pulses (TXP and TXN) and the first analog transmitter produces the differential waveform from the differential transmitting pulses.

4. The transceiver of claim 3, wherein the pair of differential waveforms are multiple cycle waveforms outputting to a first bandpass filter and a second bandpass filter, both of the first and second bandpass filters coupled onto the data network

5. The transceiver of claim 1, wherein the slicer comprises a first comparator receiving the comparing signal converted from a digital signal, a comparison of the comparing signal with the envelope signal producing the noise decision signal.

6. The transceiver of claim 5, wherein the noise decision signal is converted into one of digital control signals that are used, together with a squelch control state machine, to control a counter that in turn produces the comparing signal.

7. The transceiver of claim 6 further comprising a digital receiver, the digital receiver generating the digital signal from the squelch control state machine that decides when to raise or lower the comparing signal.

8. The transceiver of claim 7, wherein the squelch control state machine allocates a short period to allow the noise threshold level to be dynamically determined.

9. A transceiver, coupled to a data network implemented over a phone line, for dynamically adjusting sensitivity thereof, the transceiver comprising:
a digital receiver to generate a comparing signal according a predefined state in a squelch control state machine;
a first analog transmitter and a second analog transmitter receiving simultaneously transmitting time signals from a transmit time generator, wherein the first analog transmitter generates a pair of differential waveforms;
a differential amplifier coupled to the first analog transmitter and receiving the pair of differential waveforms therefrom and producing an amplified differential signal;
a rectifier coupled to the differential amplifier and receiving the amplified differential signal therefrom to produce an envelope signal; and
a slicer including a comparator coupled to the rectifier and the digital receiver and receiving respectively the envelope signal and a comparing signal therefrom, the comparator producing a noise decision signal for detecting noises in received data stream over the data network.

10. The transceiver of claim 9, wherein the squelch control state machine receives a number of input signals to determine when to raise or lower the comparing signal.

11. The transceiver of claim 10, wherein the squelch control state machine is coupled to a counter generating a digital signal of certain bits.

12. The transceiver of claim 11, wherein the comparing signal is converted from the digital signal.

13. The transceiver of claim 9, wherein the first analog transmitter, the second analog transmitter, the differential amplifier, the rectifier and the slicer are all included in an Analog Front End (AFE) circuit implemented in CMOS.

14. The transceiver of claim 13, wherein the digital receiver is also implemented in CMOS.

15. The transceiver of claim 9, wherein the first analog transmitter, the second analog transmitter, the differential amplifier, the rectifier and the slicer are all included in an Analog Front End (AFE) circuit coupled to the digital receiver, both AFE and the digital implemented in an ASIC.

16. A method for dynamically adjusting sensitivity of a transceiver coupled to a data network implemented over a phone line system, the method comprising:
determining a state from a state machine receiving a plurality of control signals, the state controlling how to generate a digital signal from a counter;
producing a comparing signal from the digital signal;
generating an envelope signal from a rectifier that receives an amplified differential signal, wherein the amplified differential signal is produced from a differential amplifier receiving differential waveforms; and
comparing the envelope signal with the comparing signal to produce a noise decision signal that is to be used to monitor noises in received data stream over the data network.

17. The method of claim 16, wherein the differential waveforms are produced from one of two drivers that both receive simultaneously transmitting time signals.

18. The method of claim 17, wherein the transmitting time signals are generated from a transmit timing generator coupled to an encoder, and wherein the encoder encodes the received data stream from the data network.

19. The method of claim 16 wherein the state relates to an event and leads to when or when not to activate a Continuous Carrier Detect (CCD) adaptation process.

20. The method of claim 19 wherein the event includes one of power-up, reset, and transmit power change.

21. The method of claim 16 further comprising monitoring a link status of the transceiver; wherein a normal noise process that is not the CCD adaptation process is activated when the link status shows a failure.

22. The method of claim 19 wherein, in the event in which a transmit power change occurs, the CCD adaptation process activated first.
